(19) United States
(12) Patent Application Publication
(10) Pub. No.: US 2009/0283653 A1
(43) Pub. Date: Nov. 19, 2009

(54) JACK STAND AND METHOD FOR FORMING SAME

(75) Inventor: Allen Shouyun Zhang, Chino Hills, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: LARIN CORPORATION, Ontario, CA (US)

(21) Appl. No.: 12/122,220

(22) Filed: May 16, 2008

(51) Int. Cl. F16M 11/20

(52) U.S. Cl. 248/352; 29/592

(57) ABSTRACT

A jack stand and method for forming the same wherein the jack stand includes a base having at least 3 elongated support legs formed from a cylindrical metallic tube. The legs are braced and have support feet at bottom and terminate at top in a hollow cylindrical collar having a throughbore. A solid post, with a saddle at top, reciprocates within the collar. The post has a plurality of horizontally extending throughbores and a locking pin is extended through the throughbore in the collar and into one of the horizontally extending throughbores in the post locking the post in various positions.

### BACKGROUND

1. Field

The present invention relates to support devices, and more particularly to adjustable support devices such as a jacks or jack stands for supporting lifted vehicles.

2. General Background

There are quite a few known types of hydraulic jack mechanisms for lifting heavy objects, such as motor vehicles, off the ground. However, many of such jacks are so large and heavy as to not be easily portable.

Jacks provided as original equipment with motor vehicles are of light weight and can be conveniently stored in a rear deck or trunk compartment of a motor vehicle yet they are not sufficiently strong for long term use.

Both types of jacks are not suitable for long-term and convenient support of a motor vehicle so that there exists a need to employ an auxiliary jack to supplement deficiencies thereof.

Such a jack stand should be economical to manufacture.

### SUMMARY

It is an object of this invention to provide a jack sta having a base with support legs made from a single piece of metallic tubing.

It is an object of this invention to provide a method for forming a jack stand wherein the support legs are cut from a steel tube.

These and other objects are preferably accomplished by providing

A jack stand and method for forming the same wherein the jack stand includes a base having at least 3 elongated support legs formed from a cylindrical metallic tube. The legs are braced and have support feet at bottom and terminate at top in a hollow cylindrical collar having a throughbore. A solid post, with a saddle at top, reciprocates within the collar. The post has a plurality of horizontally extending throughbores and a locking pin is extended through the throughbore in the collar and into one of the horizontally extending throughbores in the post locking the post in various positions.

### DRAWINGS

The above-mentioned features and objects of the present disclosure will become more apparent with reference to the following description taken in conjunction with the accompanying drawings wherein like reference numerals denote like elements and in which:

FIG. 1 is an exploded view of parts used to form a jack stand in accordance with the teachings of the invention;

FIG. 2 is an elevational view of the base of the jack stand alone with the supporting legs formed from one of the parts of FIG. 1;

FIGS. 3 and 4 are elevational views of the assembled jack stand showing the central post in raised and lowered positions, respectively; and

FIG. 5 is a top view of the jack stand of FIGS. 3 and 4 illustrating locking of the pin into one of the holes in the post of the jack stand;

### DETAILED DESCRIPTION

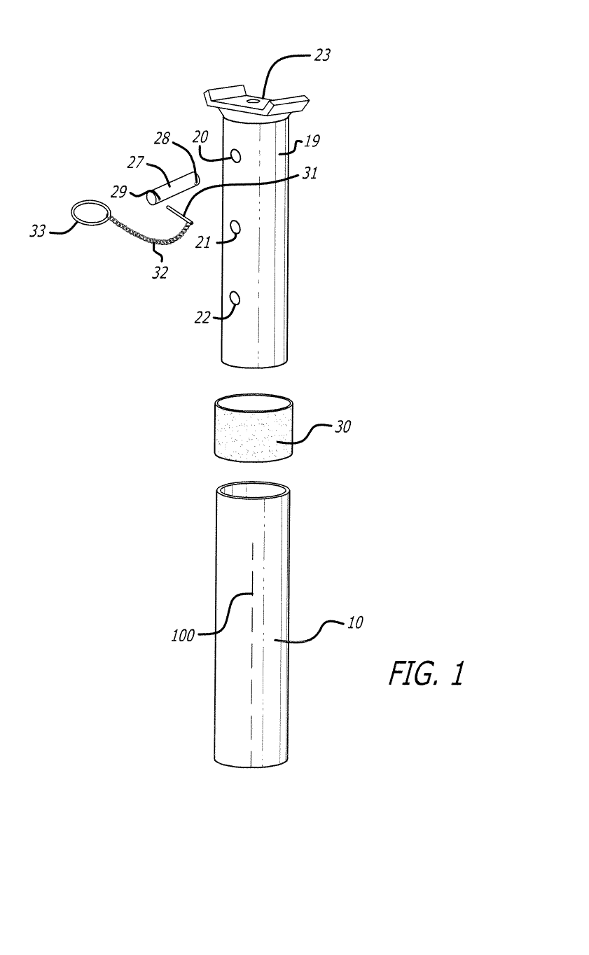

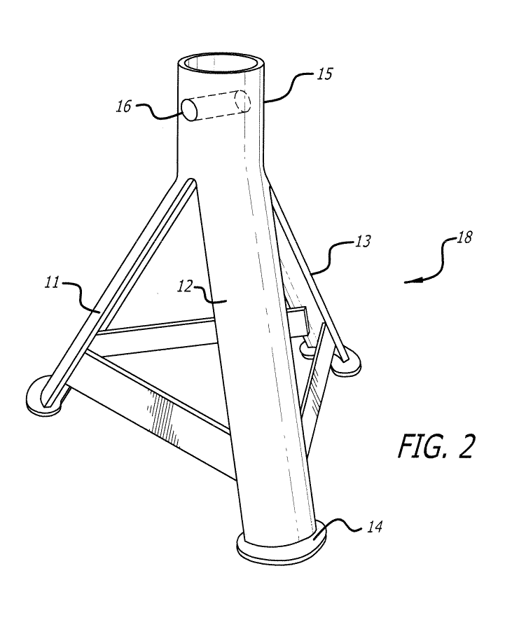

Referring now to FIG. 1 of the drawing, the jack stand 10 of the invention is shown in exploded view prior to assembly of parts. As particularly contemplated in the present invention, the supporting legs of the base of jack stand 10 are made from a single piece of hollow metallic tubing, such as steel. Thus, as seen in FIG. 1, a single piece of hollow tubing 10 is shown. As seen in FIG. 2, tubing 10 has been cut along dotted lines 100 (only one of the 3 lines in visible FIG. 1) into 3 pieces or elongated legs 11 to 13 to form a base 18 with support pads or feet 14 welded to the bottom of each leg.

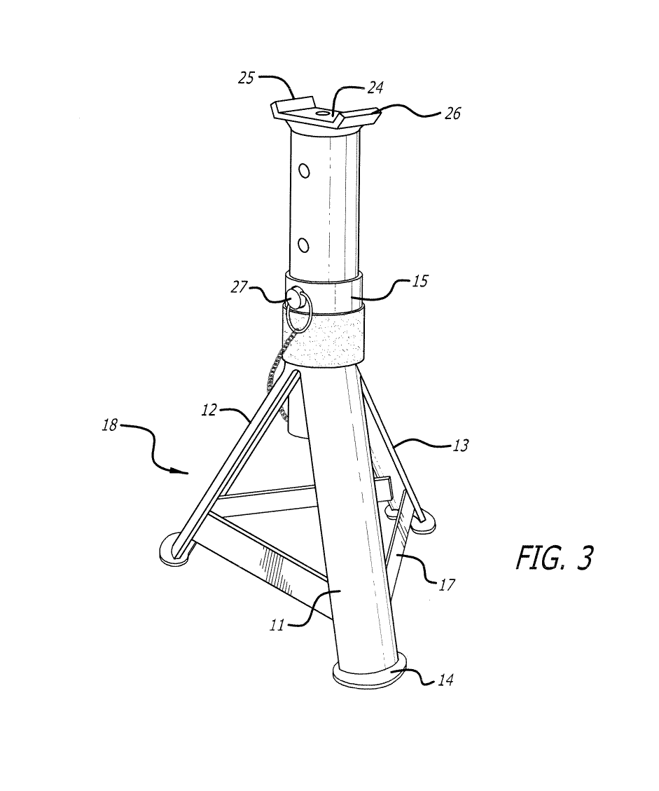

The legs 11 to 13 extend upwards forming an integral socket or collar portion 15 (see also FIG. 2). A throughbore 16 is provided through collar portion 15. Cross braces 17 extend (see FIG. 3) between the legs 11 to 13 and are welded thereto to support base 18.

As seen in FIG. 1, post 19 is generally a solid metallic cylinder having a plurality of spaced throughbores, such as throughbores 20 to 22. Post 19 terminates at top in a support saddle 23 which may be welded thereto having a central flat portion 24 (FIG. 3) with integral upwardly and outwardly extending spaced flanges 25, 26.

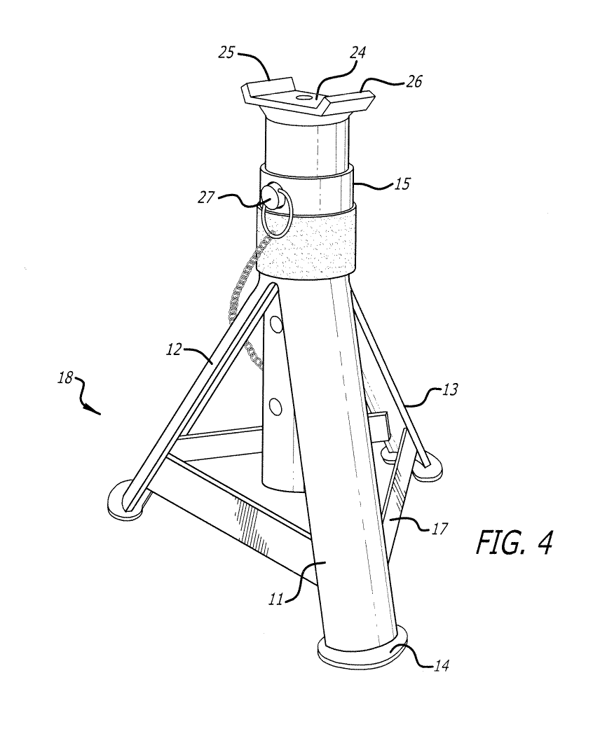

The outer diameter of post 19 conforms to the inner diameter of collar portion 15 so that it can reciprocate therein. A locking pin 27 (FIG. 1) having throughbores 28, 29 is provided having an outer diameter conforming to the inner diameter of throughbore 16 in collar portion 15. As seen in FIGS. 3 and 4, pin 27 can be extended through throughbore 16, into one of the throughbores 20 to 22 in post 19. Thus, post 19 can be locked in an upper raised position (FIG. 3) or a lowered position (FIG. 4).

A resilient cylindrical grip 30, such as a diamond tread rubber sleeve, FIG. 1, having an inner diameter relating to the outer diameter of collar position 15, is provided so that it can be extended about the collar portion 15, FIG. 3, below pin 27, to grip the same and provide a gripping means for handling jack stand 10.

As seen in FIG. 1, an elongated release pin 31 is provided having a chain 32 or the like connected thereto terminating at one end in ring 33.

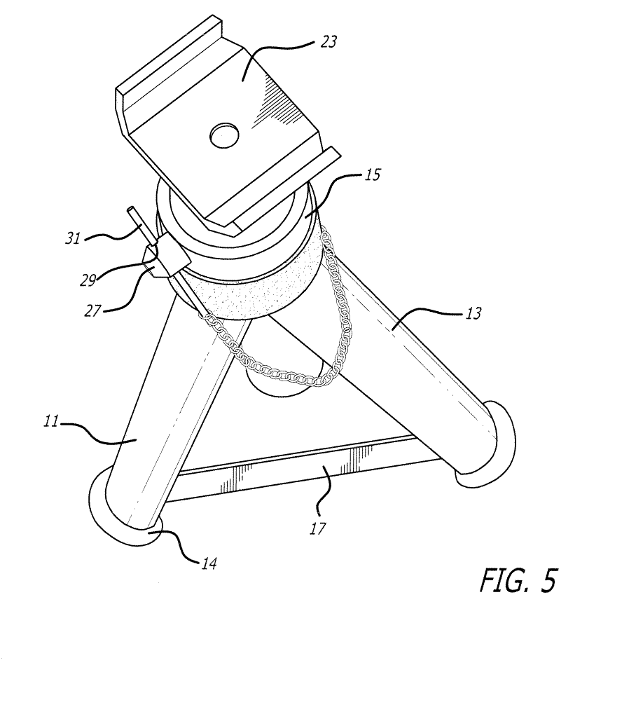

Thus, as seen in FIG. 5, pin 31 extends through hole 29 in locking pin 27, which pin 27 is shown extending through throughbore 16 in collar and aligned throughbore 20 (FIG. 1) in post 19. Ring 33 (FIG. 1) extends through hole 28 at the other end of locking pin 27 thus preventing removal therefrom.

It can be seen that there is described a jack stand that is economical to manufacture since the support legs are made from a single piece of hollow metallic tubing.

Although variations thereof may occur to an artisan, the scope of the invention should only be limited by the scope of the appended claims.

Although variations thereof may occur to an artisan, the scope of the invention should only be limited by the scope of the appended claims.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. In a jack stand including a base, an upstanding hollow socket integral with said base, a tube reciprocal within said socket terminating at top in a saddle, said socket having at least one throughbore extending horizontally therethrough, said tube having a plurality of horizontally extending throughbores spaced from each other, and a locking member extending through said at least one throughbore in said socket through at least one of said plurality of horizontally aligned throughbores in said post, the improvement which comprises:
said base being comprised of a plurality of elongated spaced legs extending downwardly from said socket, said legs being formed from a single piece of hollow metallic tubing.

2. The jack stand of claim 1 where three legs are provided.

3. The jack stand of claim 1 wherein cross bracings extend from one of said legs to another.

4. The jack stand of claim 1 wherein each leg terminates at bottom in a support foot.

5. The jack stand of claim 1 wherein said socket is a hollow collar having an inside and an outside and a resilient gripping sleeve surrounds the outside of said collar.

6. In method for forming a jack stand wherein said jack stand includes a base, an upstanding hollow socket integral with said base, a tube reciprocal written said socket terminating at top in a saddle, said socket having at least one throughbore extending horizontally therethrough, said tube having a plurality of horizontally extending throughbores spaced from each other, and a locking member extending through said at least one throughbore in said socket through at least one of said plurality of horizontally aligned throughbores in said post, the improvement which comprises the steps of:
providing an elongated piece of hollow metallic tubing having a main elongated body and a first end and a second end;
subsequently cutting said tubing partway at a plurality of spaced locations from one of said ends to a point terminating before the other of said ends thus forming a plurality of cut portions; and
subsequently bending the cut portions outwardly away from the main body of said tubing forming the supporting legs of said jack stand with said cut portions terminating at the point before the other of said ends to form said socket of said jack stand.

7. The method of claim 6 including the step of cutting out at least three cut out portions out of said tubing.

8. The method of claim 6 including the step of welding bracings between said legs.

9. The method of claim 6 including the step of welding support feet to the bottom of each said legs.

10. The method of claim 6 including the step of providing a resilient gripping sleeve on the outside of said socket.
